(19) United States
(12) Patent Application Publication
(10) Pub. No.: US 2026/0351020 A1
(43) Pub. Date: Nov. 5, 2026

(54) METHOD AND APPARATUS FOR DETECTING OBJECTS IN THREE-DIMENSIONAL SPACE

(71) Applicant: Robert Bosch GmbH, Stuttgart (DE)

(72) Inventor: Yuwen Heng, Shanghai (CN)

(21) Appl. No.: 19/659,811

(22) Filed: Apr. 27, 2026

(30) Foreign Application Priority Data
Apr. 30, 2025 (CN) 2025 1056 9941.5

(51) Int. Cl. G06V 20/64; G06T 7/55; G06V 10/82

(52) U.S. Cl. CPC G06V 20/64; G06T 7/55; G06V 10/82; G06T 2207/20084

(57) ABSTRACT

A method for detecting an object in a three-dimensional space is disclosed. The method includes: obtaining a two-dimensional feature representation based on an image acquired by an image sensor; selecting a depth prediction network for the image from a depth prediction network set based on the two-dimensional feature representation, wherein the depth prediction network set includes a plurality of depth prediction networks; determining a depth distribution of the image via the selected depth prediction network; acquiring a three-dimensional feature representation associated with the position in the three-dimensional space corresponding to the image based on the two-dimensional feature representation and the depth distribution; and detecting an object included in the image based on the three-dimensional feature representation.

This application claims priority under 35 U.S.C. § 119 to application no. CN 2025 1056 9941.5, filed on Apr. 30, 2025 in China, the disclosure of which is incorporated herein by reference in its entirety.

The present application relates to computer vision, and more particularly, to methods, apparatus, systems, computer-readable storage media, and computer program products for detecting objects in a three-dimensional space.

### BACKGROUND

As computer vision technology continues to develop, object detection methods have gradually developed from two-dimensional (2D) space to three-dimensional (3D) space. Compared to 2D object detection, 3D object detection can provide more accurate object information, and thus it is widely used in many fields, such as autonomous driving, robot navigation, and augmented reality. Typically, 3D object detection may be based on 2D images acquired from a single viewing angle or multiple viewing angles. Therefore, how to link 3D spatial position to 2D image features has an important impact on the accuracy of object detection.

In the prior art, a 2D image feature may be converted to a 3D image feature based on a depth estimate of the 2D image. In current object detection methods, a fixed range of distances, e.g., 0 to 50 meters, is typically applied to depth estimation for all images. In practical applications, however, the range of depth distances may be large depending on object detection scenarios. Further, subsequent object predictions are generally made based on location points sampled evenly in the 3D space. As the range of depth distances increases, maintaining the original sampling density will require an increase in the number of sampling points, which will take up additional computing resources and storage space; or, if the original number of sampling points is maintained to save computing resources, an increase in the sampling interval is required, which may result in incorrect object detection.

Therefore, an efficient and accurate method of detecting an object in a three-dimensional space is desirable.

### SUMMARY

The following introduction is provided in order to introduce some selected concepts in a simple manner, and these concepts will be further described in the detailed description below. The introduction is not intended to highlight the key or necessary features of the claimed subject matter, nor is it intended to limit the scope of the claimed subject matter.

3D object detection refers to a technique for detecting and identifying objects in a three-dimensional space. 3D object detection may provide more accurate object location and pose information as compared with 2D object detection, and thus is suitable for many real-world scenarios, such as autonomous driving, robot navigation, and augmented reality. For example, images of a single viewing angle or multiple viewing angles may be acquired first by an image sensor, and a 2D image feature may be obtained based on the image. A depth estimate of the image may be obtained based on the 2D image feature, and then a 3D object detection may be performed based on the depth estimate.

In some 3D object detection methods, the depth estimation of the image is typically based on a single depth prediction network, which may be trained for a fixed range of distances, e.g., within 50 meters. However, in practical applications, the range of depth distances of the object to be detected in the image may be large. In the case of autonomous driving scenarios, when a vehicle is travelling on an ordinary city road, it may pay more attention to objects within a short distance, such as within 50 meters; and when the vehicle is travelling on a highway, it also needs to pay attention to objects at a greater distance, such as 50 meters to 150 meters. If a single depth prediction network is applied, there may be a problem. Traditionally, feature extraction and subsequent object predictions may be based on location points that are evenly sampled in the 3D space. As the distance range increases, maintaining the original sampling density will require an increase in the number of sampling points, which will take up additional computing resources and storage space; or, if the original number of sampling points is maintained to save computing resources, an increase in the sampling interval is required, which may result in incorrect object detection.

On this basis, it is desirable to provide a method for detecting an object in a three-dimensional space. The method can provide a set of depth prediction networks comprising multiple depth prediction networks. During object detection, an applicable depth prediction network can be dynamically determined from the depth prediction network set based on the features of the 2D image to obtain a depth estimate of the image, and subsequent object detection can be performed based on the depth estimate. The depth prediction network selected based on the method of the present disclosure can be flexibly adapted to various object detection scenarios. In particular, when the range of depth distance is changed, there is no need to over-increase the computing overhead, and the depth information obtained can ensure the accuracy of subsequent object detection.

In one aspect, embodiments of the present disclosure provide a method for detecting an object in a three-dimensional space. The method comprises: obtaining a two-dimensional feature representation based on an image; selecting a depth prediction network for the image from a depth prediction network set based on the two-dimensional feature representation, wherein the depth prediction network set includes a plurality of depth prediction networks; determining a depth distribution of the image via the selected depth prediction network; and detecting an object included in the image in the three-dimensional space based at least on the depth distribution.

In another aspect, embodiments of the present disclosure provide a system for detecting an object in a three-dimensional space, comprising: a feature extraction module configured to obtain a two-dimensional feature representation based on an image; a network selection module configured to select a depth prediction network for the image from a depth prediction network set based on the two-dimensional feature representation, wherein the depth prediction network set includes a plurality of depth prediction networks; a depth prediction module configured to determine a depth distribution of the image via the selected depth prediction network; and an object detection module configured to detect an object included in the image in the three-dimensional space based at least on the depth distribution.

In another aspect, embodiments of the present disclosure provide a system, comprising: at least one processor; a memory coupled to the at least one processor, the memory storing executable instructions, wherein the executable instructions, when executed by the at least one processor, cause the at least one processor to implement the method according to any embodiment of the present disclosure.

In another aspect, embodiments of the present disclosure provide a computer-readable medium which stores a computer program comprising instructions that, when executed by a processor, cause one or more units to implement the method according to any embodiment of the present disclosure.

In another aspect, embodiments of the present disclosure provide a computer program product, comprising a computer program, wherein the computer program, when executed by the processor, implements the method according to any embodiment of the present disclosure.

### BRIEF DESCRIPTION OF THE DRAWINGS

The nature and advantages of the content of the present disclosure may be further understood by referring to the following accompanying drawings. In the drawings, similar components or features may have the same reference signs.

FIG. 1 illustrates a schematic diagram of a system for detecting an object in a three-dimensional space according to an embodiment of the present disclosure.

FIG. 2 illustrates a schematic diagram of a system for detecting an object in a three-dimensional space according to an embodiment of the present disclosure.

FIG. 3 illustrates a schematic diagram of a feature extraction process according to an embodiment of the present disclosure.

FIG. 4 illustrates a schematic diagram of a foreground mask process according to an embodiment of the present disclosure.

FIG. 5 illustrates a schematic diagram of a network selection process according to an embodiment of the present disclosure.

FIG. 6 illustrates a schematic diagram of a depth prediction process according to an embodiment of the present disclosure.

FIG. 7 illustrates a schematic diagram of an object detection process according to an embodiment of the present disclosure.

FIG. 8 illustrates an exemplary flow chart for detecting an object in a three-dimensional space according to an embodiment of the present disclosure.

FIG. 9 illustrates a schematic diagram of an exemplary system according to an embodiment of the present disclosure.

### DETAILED DESCRIPTION

The subject matter described herein will now be discussed with reference to exemplary embodiments. It should be understood that discussions about these embodiments are provided to aid those skilled in the art in better understanding and thereby implementing the subject matter described herein rather than limiting the scope of protection, applicability, or examples described in the patent claims. Changes may be made to the functions and arrangements of the elements discussed without departing from the scope of protection of the content of the present disclosure. Various processes or components may be omitted, substituted, or added in the various examples as needed. For example, the described method may be performed in a different order than that described, and various steps may be added, omitted, or combined. In addition, features described in relation to some examples may also be combined in other examples.

As used herein, the term “comprise” and its variations are open terms, which mean “including but not limited to”. The term “based on” indicates “at least partially based on.” The terms “one embodiment” and “an embodiment” indicate “at least one embodiment”. The term “another example” indicates “at least one other example”. The terms “first”, “second”, etc. may refer to different or same objects. Unless explicitly stated in the context, the definition of one term is consistent throughout the description.

It is to be noted that the application of the methods of the present disclosure may involve the use of information related to a user, such as information associated with a driving path, road environment. It is to be noted that the use of relevant information relating to the privacy of the user requires user authorization and its use must not exceed the scope of the user authorization.

As computer vision technology continues to evolve, the method of object detection gradually develops from two-dimensional (2D) space to three-dimensional (3D) space. Compared to 2D object detection, 3D object detection can provide more accurate object information, and thus it is widely used in many fields, such as autonomous driving, robot navigation, and augmented reality.

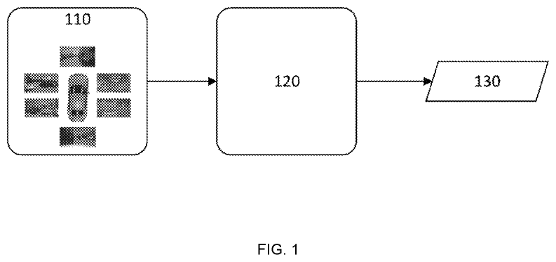

FIG. 1 illustrates a schematic diagram of a system for detecting an object in a three-dimensional space according to an embodiment of the present disclosure. The various modules provided by the present embodiment may be implemented in the form of software and/or hardware, and each module may be integrated into a computing device capable of executing the present embodiment, or may be distributed among a plurality of computing devices capable of executing the present embodiment. It should be understood that the following examples are provided solely to enhance understanding of the present disclosure and do not impose any limitations on the scope of the present disclosure.

Typically, the 3D object detection may be based on 2D images that may be acquired with a single or multiple image sensors at a single viewing angle or multiple viewing angles. Taking the autonomous driving scenario as an example, as shown in 110 in FIG. 1, multi-view 2D images of the surrounding of the vehicle can be acquired by 6 image sensors mounted on the vehicle body to serve as an input for a 3D object detection system 120. For example, the image sensor may be a camera or any image sensor applicable in the art. It is contemplated that the 3D object detection system 120 can output a prediction 130 of a 3D object included in the image based on features of the 2D image from the input 110. For example, the prediction 130 of the 3D object may include a prediction of a plurality of 3D objects in the acquired image. For example, the prediction 130 for each 3D object may include information such as the location, type, and orientation of the object. For example, the location of the object to be detected may be represented by the coordinates of its bounding box in the three-dimensional space. For example, the types of objects to be detected may include vehicles, pedestrians, trees, railings, etc. Additionally, the types of objects to be detected may include lane lines and traffic sign information, such as solid lines, dashed lines, turns, straight ahead, and no stopping. For example, the orientation of the object to be detected may be represented by a deflection angle to various reference points or reference planes. In an embodiment, the prediction 130 may be used for various downstream tasks, such as path planning, automatic parking, and collision avoidance. It is to be noted that while described herein with the autonomous driving scenario as a primary example, 3D object detection methods in the present disclosure may be applicable to a variety of practical applications, not limited to this example. Specific implementations of a system of the present disclosure for detecting an object in a three-dimensional space will be described below with reference to the accompanying drawings.

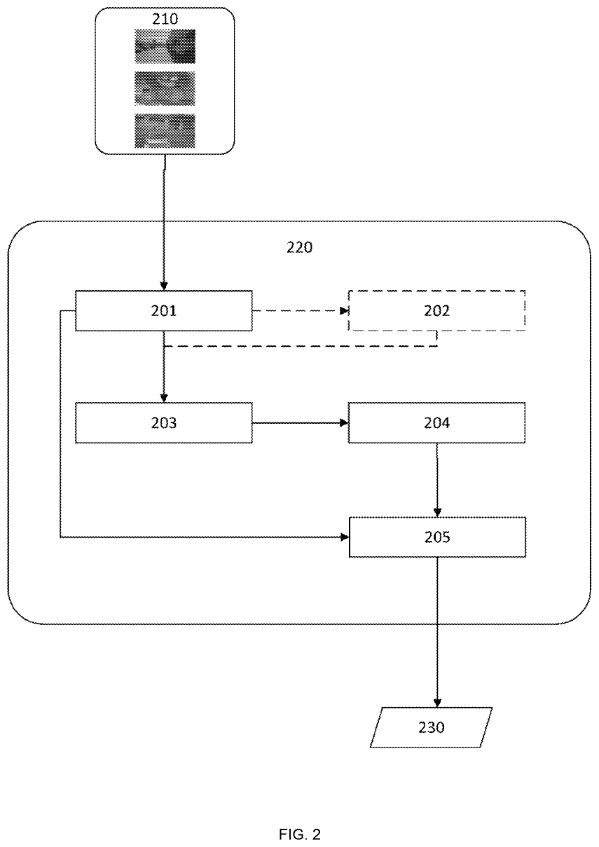

FIG. 2 illustrates a schematic diagram of a system for detecting an object in a three-dimensional space according to an embodiment of the present disclosure. The various modules provided by the present embodiment may be implemented in the form of software and/or hardware, and each module may be integrated into a computing device capable of executing the present embodiment, or may be distributed among a plurality of computing devices capable of executing the present embodiment. For example, the computing device may be an electronic control unit (ECU) mounted in a vehicle, a central processing unit (CPU) installed in a roadside unit, a central processor installed in a cloud server, or the like. It should be understood that the following examples are provided solely to enhance understanding of the present disclosure and do not impose any limitations on the scope of the present disclosure.

As described above, a single or multiple viewing angle 2D image of the surrounding environment may be acquired by one or more image sensors to serve as an input to the 3D object detection system. As shown in 210 in FIG. 2, 2D images from 3 viewing angles can be acquired by 3 image sensors to serve as inputs to the 3D object detection system 220. Note that other image sensors and other numbers of images are possible. In an embodiment, the 3D object detection system 220 may include a feature extraction module 201, a foreground mask module 202 (optional), a network selection module 203, a depth prediction module 204, and an object prediction module 205. Although not fully shown in FIG. 2, each of these modules may communicate directly or indirectly with each other. As disclosed herein, the 3D object detection system 220 can output a prediction 230 of a 3D object based on features of the 2D image from the input 210.

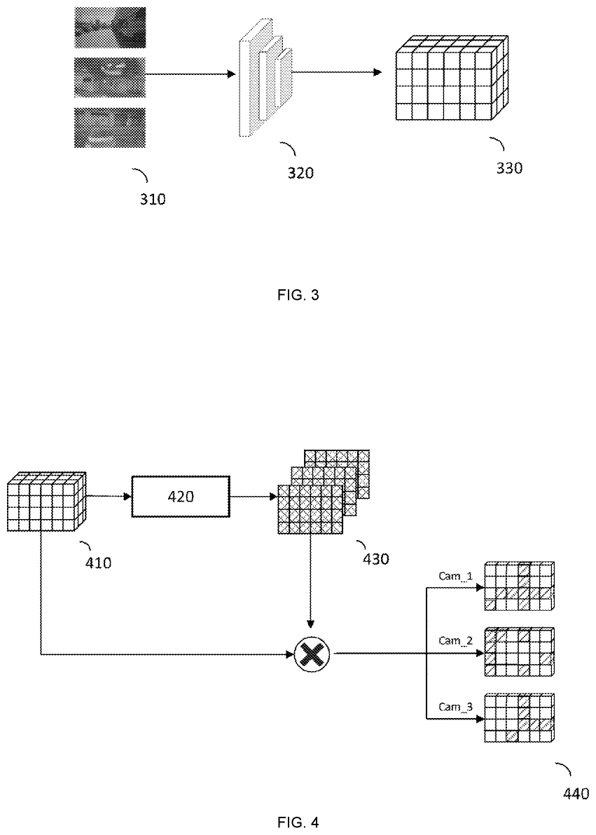

For example, a corresponding two-dimensional feature representation may be obtained by the feature extraction module 201 using the 2D image as an input. A schematic diagram of a feature extraction process that may be implemented by the feature extraction module 201 is shown in connection with FIG. 3. The various steps provided in the present embodiment may be implemented by one or more devices with computing capabilities by way of software and/or hardware.

As shown in FIG. 3, a corresponding two-dimensional feature representation 330 may be obtained by a feature extraction network 320 using a 2D image from 3 viewing angles acquired by 3 image sensors as an input 310. In an embodiment, the feature extraction network 320 may be implemented based on a convolutional neural network (CNN) model, such as ResNet. Additionally, the feature extraction network 320 may be implemented based on a Transformer model, such as Transformer Swin. Additionally, the feature extraction network 320 may be implemented based on any of the image feature extraction methods applicable in the art.

In an embodiment, the two-dimensional feature representation 330 may be expressed as a feature map, which may have H×W×C×Cam_Num dimensions, where H represents the height of the image, W represents the width of the image, C represents the number of feature channels for each pixel point, and Cam_Num may represent the number of images. In the present embodiment, Cam_Num equals the number of image sensors, Cam_Num=3. Additionally, the two-dimensional feature representation 330 may be represented in other suitable forms such as feature vectors, feature matrices, and feature tensors.

In practical applications, the range of depth distance of an object to be detected in the image may be large and may change with time and scene. In addition, the range of depth distance of the object to be detected in the image acquired at different viewing angles may also vary. In the case of autonomous driving scenarios, when a vehicle is travelling on an ordinary city road, it may pay more attention to objects within a short distance, such as within 50 meters. When the vehicle is travelling on a highway, it needs to pay attention to objects at a greater distance, such as 50 meters to 200 meters. When a vehicle is travelling on a highway, most of the objects to be detected may be far away from the vehicle, such as 50 meters away or more. However, when other vehicles merge, they will be closer to the vehicle, such as 10 meters away. The merging vehicle may be captured first by an image sensor on the side of the vehicle, and then the merging vehicle will appear in an image captured by an image sensor on the front of the vehicle. In this instance, the use of a single depth prediction network may result in a limited detection distance and incorrect object detection. On this basis, the present disclosure provides a set of depth prediction networks comprising multiple depth prediction networks. An applicable depth prediction network can be dynamically selected from the depth prediction network set based on the features of the image to obtain a depth distribution of the image.

In an embodiment, the depth prediction network set may include a plurality of depth prediction networks. For example, each depth prediction network may be suitable for different distance ranges, a depth prediction network 1 for 0 to 50 meters, a depth prediction network 2 for 50 to 100 meters, and a depth prediction network 3 for 100 to 200 meters. Additionally, or alternatively, the applicable distance ranges of each depth prediction network may be partially overlapping. For another example, each depth prediction network may be suitable for different application scenarios. Taking the autonomous driving scenario as an example, the depth prediction network 1 may be suitable for “urban driving,” the depth prediction network 2 may be suitable for “rural driving,” and the depth prediction network 3 may be suitable for “high speed driving.”

Returning to FIG. 2, an applicable depth prediction network to be selected from the depth prediction network set may be determined by the network selection module 203 using a two-dimensional feature representation output by the feature extraction module 201 as an input.

Optionally, the two-dimensional feature representation output by the feature extraction module 201 can be used as an input to first identify an area of the image associated with one or more objects to be detected by a foreground mask module 202. The portion of the two-dimensional feature representation corresponding to the area associated with one or more objects to be detected can then be used as an input to determine, by the network selection module 203, an applicable depth prediction network to be selected from the depth prediction network set. As a subsequent object detection task is to be performed, it may be more beneficial to make a depth prediction network selection based on some of the features corresponding to the object to be detected rather than the features of the entire image. A schematic diagram of a foreground mask process that may be implemented by the foreground mask module 202 is shown in connection with FIG. 4. The various steps provided in the present embodiment may be implemented by one or more devices with computing capabilities by way of software and/or hardware.

As shown in FIG. 4, a two-dimensional feature representation 410 obtained based on the image may be used as an input to identify an area of the image associated with one or more objects to be detected by a foreground mask network 420 to obtain a foreground mask 430 corresponding to the various images. Here, the two-dimensional feature representation 410 may be an example of the two-dimensional feature representation 330 in FIG. 3. In an embodiment, the foreground mask network 420 may be implemented based on a convolutional neural network (CNN) model, such as a fully convolutional (FCN) network. Additionally, the foreground mask network 420 may be implemented based on any object segmentation method applicable in the art.

In an embodiment, the foreground mask 430 may include Cam_Num mask matrices corresponding to Cam_Num images, as shown in FIG. 4, Cam_Num=3. Each mask matrix may have the same length and width as the image to be applied to, such as H×W. Additionally, the mask matrix may have a smaller length and width than the image to be applied to. For example, the mask matrix may be a Boolean matrix, where the matrix element corresponding to the area in which the object to be detected is present is 1, and the matrix element corresponding to the area in which the object to be detected is not present is 0. Additionally, the foreground mask 430 may be represented in any other suitable form capable of identifying an object area to be detected.

As shown in FIG. 4, the foreground mask 430 may be applied to the two-dimensional feature representation 410 to obtain a masked two-dimensional feature representation 440 corresponding to each image. Here, a blank area of the two-dimensional feature representation 440 represents a portion of the feature representation corresponding to an image area where the object to be detected is present, and a slashed area represents a portion of the feature representation corresponding to an image area where the object to be detected is not present. In an embodiment, the application of the foreground mask 430 may include multiplying the mask matrix with a two-dimensional feature representation of a corresponding image.

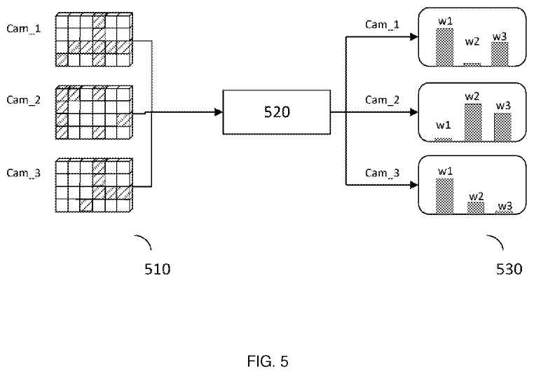

With continued reference to the description above in conjunction with FIG. 2, the two-dimensional feature representation 330 or the masked two-dimensional feature representation 440 may be used as input to the network selection module 203 to determine the applicable depth prediction network to be selected from the depth prediction network set. A schematic diagram of a network selection process that may be implemented by the network selection module 203 is shown in connection with FIG. 5. The various steps provided in the present example may be implemented by one or more devices with computing capabilities by way of software and/or hardware.

As shown in FIG. 5, for example, a masked two-dimensional feature representation 510 may be input into a network selection module 520 to select a depth prediction network. In an embodiment, the network selection module 520 may collectively determine a depth prediction network to be selected for one or more images in the multi-view image. Additionally, or alternatively, the network selection module 520 may individually determine a depth prediction network to be selected for each image. For example, the network selection module 520 may output an index of a depth prediction network to be selected. Additionally, or alternatively, as shown in FIG. 5, the network selection module 520 may output a weight 530 for the depth prediction network to be selected, wherein the weight for the unselected depth prediction network may be zeroed. Here, the masked two-dimensional feature representation 510 may be an example of the masked two-dimensional feature representation 440 in FIG. 4. Additionally, or alternatively, as described above, the two-dimensional feature representations 330 or 410 may also be input directly into the network selection module 520.

In an embodiment, the network selection module 520 may be implemented based on a convolutional neural network (CNN) model. For example, the network selection module 520 may be implemented based on the structure of a convolutional layer, a flattening layer, a fully connected layer, and an activation layer (such as a softmax function). Additionally, the network selection module 520 may be implemented based on any method applicable in the art.

In an embodiment, the number of depth prediction networks to be selected from the depth prediction network set may be pre-set. As shown in FIG. 5, the depth prediction network set includes 3 depth prediction networks, and the number of depth prediction networks to be selected may be pre-set to 2, so the index and/or weight for the depth prediction network to be selected may include 2 valid values. Here, the sum of the valid weight values for a single image is 1, and the weight for a depth prediction network that is not selected may be zeroed.

In another embodiment, the number of depth prediction networks to be selected may be determined by the network selection module 520. For example, the depth prediction network set includes 3 depth prediction networks and the network selection module 520 may determine that 2 depth prediction networks are to be selected for each image based on the two-dimensional feature representation 510. Additionally, or alternatively, the network selection module 520 may determine the number of depth prediction networks to be selected based on a two-dimensional feature representation corresponding to each image. For example, the network selection module 520 may determine to use one depth prediction network for image 1 and two depth prediction networks for image 2 and image 3.

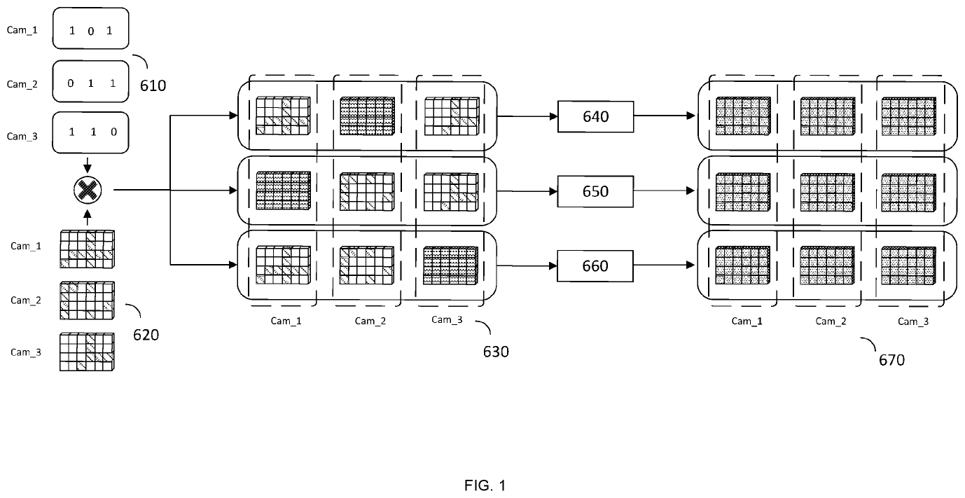

Returning to FIG. 2, the selected depth prediction network determined by the network selection module 203 and the two-dimensional feature representation of each image may be used as inputs to determine the depth distribution of each image by the depth prediction module 204. A schematic diagram of a depth prediction process that may be implemented by the depth prediction module 204 is shown in connection with FIG. 6. The various steps provided in the present embodiment may be implemented by one or more devices with computing capabilities by way of software and/or hardware.

As shown in FIG. 6, a two-dimensional feature representation 620 of the image may be fed to a corresponding depth prediction network based on a depth prediction network index 610 selected for the various images to obtain a depth distribution prediction. Here, the two-dimensional feature representation 620 may be an example of the masked two-dimensional feature representation 440 or 510 in FIGS. 4 and 5, or may be an example of the two-dimensional feature representation 330 or 410 in FIGS. 3 and 4.

As shown in 630, a first depth prediction network 640 and a third depth prediction network 660 were selected for image 1, so only the first and third rows in the first column have valid values corresponding to the two-dimensional feature representation of image 1; a second depth prediction network 650 and the third depth prediction network 660 were selected for image 2, and the second and third rows in the second column have valid values corresponding to the two-dimensional feature representation of image 2; and the first depth prediction network 640 and the second depth prediction network 650 were selected for image 3, and the first and second rows in the third column have valid values corresponding to the two-dimensional feature representation of image 3. In a specific implementation, in order to ensure the sequence of inputs and outputs, the two-dimensional features that are not fed into the depth prediction network may all be zeroed, as shown by the horizontal line areas in 630.

Subsequently, each depth prediction network may output a depth distribution prediction based on the received two-dimensional feature representation. As shown in 670, the first row is a depth distribution prediction for individual images output by the first depth prediction network 640, the second row is a depth distribution prediction for individual images output by the second depth prediction network 650, and the third row is a depth distribution prediction for individual images output by the third depth prediction network 660.

In an embodiment, the depth prediction network may be implemented based on a fully connected network model or any manner applicable in the art.

As described above, the various depth prediction networks in the depth prediction network set may be pre-trained for different distance ranges or different application scenarios. In an embodiment, when each depth prediction network is configured for different distance ranges, the output depth distribution prediction may be normalized based on the distance configuration. For example, the depth prediction network 1 is suitable for 0 to 50 meters, the depth prediction network 2 is suitable for 50 to 100 meters, and the depth prediction network 3 may be suitable for 100 to 200 meters, so that the depth distribution prediction output by each depth prediction network may be normalized to [0, 0.25], [0.25, 0.5], and [0.5, 1] based on the distance configuration, respectively.

By way of the methods proposed in the present disclosure, applicable depth prediction networks can be dynamically determined based on the features of the input images, resulting in more accurate depth distribution predictions.

Returning to FIG. 2, the depth distribution prediction determined by the depth prediction module 204 may be used as input to detect objects included in various images in the three-dimensional space by the object detection module 205. Additionally, a two-dimensional feature representation of the image determined by the feature extraction module 202 may also be input into the object detection module 205.

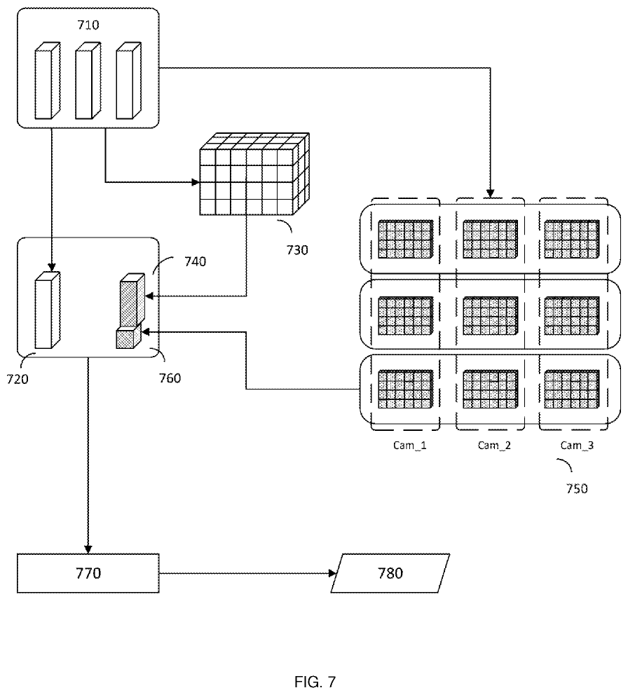

It will be understood that the object detection module 205 may be implemented based on any object detection algorithm or model applicable in the art, such as a Transformer model and a Mamba model. Exemplarily, a 3D spatial position may be linked to 2D image features and depth information by an object detection module based on the Transformer model, thereby predicting directly in the 3D space. Moreover, the number of query vectors may be set to a maximum number of objects that may be detected, and even if the range of depth distance changes, there is no need to increase the sampling points, thus saving computational overhead. A schematic diagram of an object detection process that may be implemented by the object detection module 205 is shown in connection with FIG. 7. The various steps provided in the present embodiment may be implemented by one or more devices with computing capabilities by way of software and/or hardware.

In order to detect an object in the three-dimensional space, as shown in FIG. 7, a 3D object query set 710 may first be constructed and initialized, which may include N 3D query vectors (query), where N may correspond to a maximum number of objects that may be detected in the three-dimensional space, such as 100. Each query vector may correspond to one predicted bounding box in the three-dimensional space, and the center point of the predicted bounding box may serve as a 3D position reference point corresponding to that query vector.

In an embodiment, the three-dimensional space may be described by a bird's-eye view (BEV). Two-dimensional plane data can be converted to a three-dimensional view when looked from above through the BEV view without blocking or scaling issues in the 2D detection, which can provide a more comprehensive and accurate object detection.

Subsequently, in order to link the 3D query vector in 710 to a corresponding 2D image feature, the 3D position reference points of each query vector may be projected to a pixel point on the 2D plane by a calibration matrix (e.g., based on the camera's internal and external references) before updating and refining the 3D feature representation corresponding to the query vector according to the 2D image features of the pixel point.

Using the query vector 720 as an example, the 3D position reference points corresponding to the query vector 720 may be projected through the calibration matrix to corresponding pixel points on the 2D plane. Based on the corresponding pixel point to which the 3D position reference point is projected, a 2D image feature for the pixel point may be obtained. In an embodiment, the 3D position reference point corresponding to the query vector 720 may not be projected into the image of some of the viewing angles, or may be projected simultaneously to corresponding pixel points in multiple images of different viewing angles, in the case of a multi-view image. For example, a 2D image feature corresponding to the 3D position reference point may be a weighted average of the 2D image feature obtained based on a corresponding pixel point in all images for which it is projected. It will be understood that other applicable processing methods in the art are possible.

The 2D image feature of the pixel point may include a two-dimensional image feature 740 and depth information 760. Here, the two-dimensional image feature 740 may be obtained based on a two-dimensional image feature representation 730 based on the position of the pixel point. Here, the two-dimensional image feature representation 730 may be obtained from a single-view image or a multi-view image according to the position of the pixel point. The two-dimensional image feature representation 730 may be an example of the two-dimensional image feature representation 330 in FIG. 3 and the two-dimensional image feature representation 410 in FIG. 4. Here, the depth information 760 may be obtained based on the depth distribution prediction 750 according to the position of the pixel point. Here, the depth information 760 may be obtained by sampling a depth distribution prediction of a single-view or multi-view image based on the position of the pixel point. The depth distribution prediction 750 may be an example of the depth distribution prediction 670 in FIG. 6.

In an embodiment, sampling may be performed based on the depth distribution prediction 750 based on the position of the pixel point to obtain depth information at the corresponding position. Additionally, as disclosed herein, when a plurality of depth prediction networks are selected for a single image, and therefore a plurality of depth distribution predictions are generated, the depth information of the sampling may be obtained separately based on the plurality of depth distribution predictions. For example, the plurality of depth information may be weighted according to the weight 530 for a depth prediction network described above, with the weighted depth information as depth information for the pixel point. For another example, a plurality of depth information may be averaged as depth information for the pixel point when the network selection module has not determined weights for different depth prediction networks.

Subsequently, after multiple updates and iterations of the 3D feature representation of the query vector, a prediction 780 corresponding to the query vector 720 may be obtained based on the updated 3D feature representation by the prediction network 770. In an embodiment, the prediction network 770 may be implemented based on a Transformer model decoder. In an embodiment, the prediction network 770 may be implemented based on a regression algorithm and/or a classification algorithm. In an embodiment, the prediction 780 may include a position, type, and orientation of an object.

Returning to FIG. 2, the object prediction module 205 may output a prediction 230 for a set of query vectors. In an embodiment, the prediction 780 may include a position, type, and orientation of an object. Additionally, for a query vector where no corresponding object was detected, the object type may be output as no object.

As previously described, the methods proposed by the present disclosure can, in the first instance, dynamically determine an applicable depth prediction network based on the features of the input image to obtain more accurate depth information for pixel points on the 2D plane. Furthermore, based on the depth information, the 3D target prediction can be flexibly adapted to various object detection scenarios. Especially when the range of the depth distance changes, it can ensure the accuracy of the object detection without the need to excessively increase computational overhead.

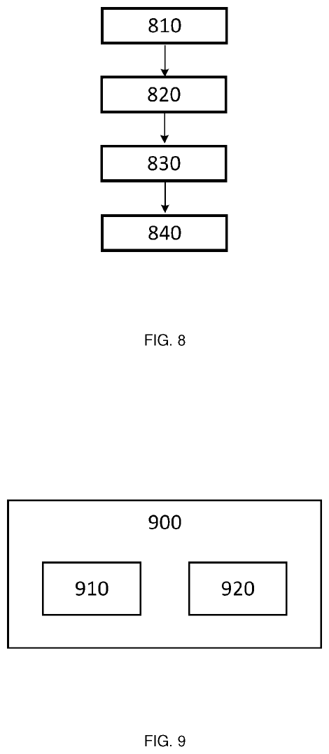

FIG. 8 illustrates an exemplary flow chart for detecting an object in a three-dimensional space according to an embodiment of the present disclosure. The various steps provided in the present embodiment may be implemented by one or more devices with computing capabilities by way of software and/or hardware.

At step 810, a two-dimensional feature representation may be obtained based on an image. For example, step 810 may be implemented by the feature extraction module 201 described in connection with FIGS. 2 and 3.

In an embodiment, the two-dimensional feature representation may be obtained based on one or more of: a convolutional neural network (CNN) model, such as ResNet; a Transformer model, such as Swin.

In an embodiment, a plurality of images of the surrounding environment may be acquired at multiple viewing angles by an image sensor, and corresponding two-dimensional feature representations may be obtained based on each of the plurality of images.

In an embodiment, a two-dimensional feature representation may be represented in various applicable forms such as a feature map, a feature vector, a feature matrix, and a feature tensor.

At step 820, a depth prediction network for an image may be selected from a depth prediction network set based on a two-dimensional feature representation, wherein the depth prediction network set includes a plurality of depth prediction networks. For example, step 820 may be implemented by the network selection module 203 described in connection with FIGS. 2 and 5.

In an embodiment, an image area associated with one or more objects to be detected included in the image may be identified based on a two-dimensional feature representation, and further, a depth prediction network for the image is selected from the depth prediction network set based on the portion of the two-dimensional feature representation corresponding to the identified image area. For example, an image area associated with one or more objects to be detected included in the image may be identified by a mask matrix, which may be a Boolean matrix, where the matrix element corresponding to the area in which the object to be detected is present is 1, and the matrix element corresponding to the area in which the object to be detected is not present is 0.

In an embodiment, the image area associated with one or more objects to be detected included in the image may be identified based on a convolutional neural network (CNN) model, such as a fully convolutional network.

In an embodiment, each depth prediction network of the plurality of depth prediction networks may be adapted to different distance ranges or different application scenarios. For example, each depth prediction network may be suitable for different distance ranges, the depth prediction network 1 for 0 to 50 meters, the depth prediction network 2 for 50 to 100 meters, and the depth prediction network 3 for 100 to 200 meters. Additionally, or alternatively, the applicable distance ranges of each depth prediction network may be partially overlapping. For another example, each depth prediction network may be suitable for different application scenarios. Taking the autonomous driving scenario as an example, the depth prediction network 1 may be suitable for “urban driving,” the depth prediction network 2 may be suitable for “rural driving,” and the depth prediction network 3 may be suitable for “high speed driving.”

In an embodiment, a depth prediction network to be selected may be uniformly determined for one or more images. Additionally, or alternatively, a depth prediction network to be selected may be individually determined for each image.

In an embodiment, the number of depth prediction networks to be selected from the depth prediction network set may be predetermined. Additionally, or alternatively, the number of depth prediction networks to be selected from the depth prediction network set may be determined based on a two-dimensional feature representation.

In an embodiment, an index of the depth prediction network to be selected may be determined based on the two-dimensional feature representation.

In an embodiment, a weight for the selected depth prediction network may be determined based on the two-dimensional feature representation. Here, the weights for the unselected depth prediction networks may be zeroed.

In an embodiment, the depth prediction network may be selected from the depth prediction network set based on a convolutional neural network (CNN) model. For example, the CNN model may have a convolutional layer, a flattening layer, a fully connected layer, and an activation layer (such as a softmax function).

At step 830, the depth distribution of the image may be determined by the selected depth prediction network. For example, step 830 may be implemented by the depth prediction module 204 described in connection with FIGS. 2 and 6.

In an embodiment, the depth prediction network is implemented based on a fully connected network model.

In an embodiment, the depth distribution prediction of the image is output by a selected plurality of depth prediction networks based on the two-dimensional feature representation of the image, respectively.

In an embodiment, the depth prediction network may be implemented based on a fully connected network model.

In an embodiment, when each depth prediction network is configured for different distance ranges, the output depth distribution prediction may be normalized according to the distance configuration.

At step 840, the object included in the image may be detected in the three-dimensional space based at least on the depth distribution. For example, step 840 may be implemented by the object detection module 205 described in connection with FIGS. 2 and 7.

In an embodiment, a three-dimensional feature representation associated with a position in a three-dimensional space corresponding to the image may be obtained based on a depth distribution and a two-dimensional feature representation, and an object included in the image may be detected based on the three-dimensional feature representation.

In an embodiment, a position reference point in the three-dimensional space may be projected to a pixel point on a two-dimensional plane; depth information associated with the pixel point is obtained based on a depth distribution prediction determined by each depth prediction network; the depth information associated with the pixel point is weighted based on a weight of the selected depth prediction network; and a three-dimensional feature representation of the position reference point in the three-dimensional space is obtained based on weighted depth information and two-dimensional feature representation associated with the pixel point. Additionally, or alternatively, when the weights used for different depth prediction networks are not determined, multiple depth information may be averaged to serve as the depth information for the pixel point.

In an embodiment, the three-dimensional space is described by a bird's-eye view (BEV).

In an embodiment, the type, location, and/or orientation of the object included in the image is detected. For example, the types of objects to be detected may include vehicles, pedestrians, trees, railings, etc. Additionally, the types of objects to be detected may include lane lines and traffic sign information, such as solid lines, dashed lines, turns, straight ahead, and no stopping. For example, the location of the object to be detected may be represented by the coordinates of its bounding box in the three-dimensional space. For example, the orientation of the object to be detected may be represented by a deflection angle to various reference points or reference planes.

In an embodiment, the information associated with the detected object may be used for various downstream tasks, such as path planning, automatic parking, and collision avoidance, in an autonomous driving scene.

In an embodiment, the object is detected based on a Transformer model. In an embodiment, the object is detected based on a Mamba model.

FIG. 9 is a block diagram of a system according to an embodiment of the present disclosure.

The system 900 may comprise one or more processors 910 and a memory 920. The memory 920 may store executable instructions. The processor 910 may execute the executable instructions stored or encoded in the memory 920, thereby implementing the various operations and/or functions described above in conjunction with FIGS. 1 to 8. Although not shown in FIG. 9, those skilled in the art may appreciate that the system 900 may comprise various other components, such as various communication modules, bus modules, and possible user interface modules. In an embodiment, the memory 920 may also store one or more of a training dataset, an unlabeled dataset, or a labeled dataset.

The embodiments of the present disclosure further provide a computer-readable storage medium. The computer-readable storage medium may store executable instructions, and the executable instructions may implement the various operations and/or functions described above in conjunction with FIGS. 1 to 8 when executed by the processor. For example, the computer-readable storage medium may include, but is not limited to, Random Access Memory (RAM), Read-Only Memory (ROM), Electrically-Erasable Programmable Read-Only Memory (EEPROM), Static Random Access Memory (SRAM), hard disk, flash memory, and the like.

Embodiments of the present disclosure also provide a computer program product. The computer program product may comprise a computer program. The computer program, when executed by a processor, may implement the various operations and/or functions described above in conjunction with FIGS. 1 to 8.

The specific embodiments of the present disclosure have been described above. Other examples are within the scope of the appended patent claims. In some cases, actions or steps described in the patent claims can be performed in a different order than that of the examples and still achieve the desired results. Additionally, the processes depicted in the drawings do not necessarily require specific or continuous sequences to achieve the desired results. In certain embodiments, multitasking and parallel processing are also possible or may be advantageous.

Not all steps and units depicted in the above-mentioned flowcharts and system diagrams are required; certain steps or units may be omitted based on actual needs. The apparatus structures described in the above-mentioned examples can be physical or logical structures. That is, some units may be realized by the same physical entity, while others may be realized by multiple physical entities or may be jointly realized by certain components in multiple separate devices.

Throughout the present Description, the term “exemplary” means “serving as an example, instance, or illustration” and does not imply “preferred” or “advantageous” over other examples. Specific embodiments comprise specific details to facilitate understanding of the described technology. However, these technologies may be implemented without these specific details. In some instances, to avoid causing difficulties in understanding the concepts of the described examples, known structures and apparatuses are shown in block diagram form.

The aforementioned description of the present disclosure is provided to allow any person of ordinary skill in the art to implement or use the present disclosure. Various modifications to the present disclosure will be apparent to those of ordinary skill in the art, and the general principles defined herein may be applied to other variations without departing from the scope of protection of the present disclosure. Therefore, the present disclosure is not limited to the examples and designs described herein but is consistent with the broadest scope defined by the principles and novel features disclosed herein.

What is claimed is:

1. A method for detecting an object in a three-dimensional space, comprising:
obtaining a two-dimensional feature representation based on an image;
selecting a depth prediction network for the image from a depth prediction network set based on the two-dimensional feature representation, wherein the depth prediction network set includes a plurality of depth prediction networks;
determining a depth distribution of the image via the selected depth prediction network; and
detecting an object included in the image in the three-dimensional space based at least on the depth distribution.

2. The method according to claim 1, further comprising:
identifying an image area associated with one or more objects to be detected included in the image based on the two-dimensional feature representation,
wherein selecting a depth prediction network for the image from the depth prediction network set based on the two-dimensional feature representation comprises selecting a depth prediction network for the image from the depth prediction network set based on a portion of the two-dimensional feature representation corresponding to the identified image area.

3. The method according to claim 2, wherein the image area associated with one or more objects to be detected included in the image is identified using a convolutional neural network model.

4. The method according to claim 1, wherein the two-dimensional feature representation is obtained based on one or more of the following: a convolutional neural network model and a Transformer model;
the depth prediction network is selected from the depth prediction network set based on the convolutional neural network model; and/or
the depth prediction network is implemented based on a fully connected network model.

5. The method according to claim 1, wherein each depth prediction network of the plurality of depth prediction networks is suitable for different distance ranges or different application scenarios.

6. The method according to claim 1, wherein selecting a depth prediction network for the image from the depth prediction network set based on the two-dimensional feature representation comprises:
determining the number of the depth prediction networks to be selected from the depth prediction network set based on the two-dimensional feature representation; and/or
determining a weight for the selected depth prediction network based on the two-dimensional feature representation.

7. The method according to claim 6, wherein detecting an object included in the image in a three-dimensional space based at least on the depth distribution comprises:
obtaining a three-dimensional feature representation associated with a location in a three-dimensional space corresponding to the image based on the depth distribution and the two-dimensional feature representation; and
detecting an object included in the image based on the three-dimensional feature representation.

8. The method according to claim 7, wherein obtaining a three-dimensional feature representation associated with a location in a three-dimensional space corresponding to the image based on the depth distribution and the two-dimensional feature representation comprises:
projecting a position reference point in the three-dimensional space to a pixel point on a two-dimensional plane;
obtaining depth information associated with the pixel point based on a depth distribution determined by each selected depth prediction network;
weighting the depth information associated with the pixel point based on the weight for the selected depth prediction network; and
obtaining the three-dimensional feature representation of the position reference point in the three-dimensional space based on the weighted depth information associated with the pixel point and the two-dimensional feature representation.

9. The method according to claim 1, wherein the three-dimensional space is described by a bird's-eye view.

10. The method according to claim 1, wherein detecting an object included in the image in the three-dimensional space comprises: detecting a type, location, and/or orientation of an object included in the image, and wherein the object is detected based on a Transformer model or a Mamba model.

11. The method according to claim 1, wherein obtaining a two-dimensional feature representation based on an image comprises:
acquiring a plurality of images of a surrounding environment from multiple viewing angles by an image sensor; and
obtaining a corresponding two-dimensional feature representation based on each image of the plurality of images;
and wherein selecting a depth prediction network for the image from the depth prediction network set based on the two-dimensional feature representation comprises:
selecting a depth prediction network for a corresponding image from the depth prediction network set based on a two-dimensional feature representation corresponding to each image of the plurality of images.

12. A system for detecting an object in a three-dimensional space, comprising:
a feature extraction module configured to obtain a two-dimensional feature representation based on an image;
a network selection module configured to select a depth prediction network for the image from a depth prediction network set based on the two-dimensional feature representation, wherein the depth prediction network set includes a plurality of depth prediction networks;
a depth prediction module configured to determine a depth distribution of the image by the selected depth prediction network; and
an object detection module configured to detect an object included in the image in the three-dimensional space based at least on the depth distribution.

13. A system comprising:
at least one processor; and
a memory coupled to the at least one processor, the memory storing executable instructions, wherein the executable instructions, when executed by the at least one processor, cause the at least one processor to implement the method according to claim 1.

14. A computer-readable medium storing a computer program comprising instructions, wherein the instructions, when executed by a processor, cause one or more units to perform the method according to claim 1.

15. A computer program product comprising a computer program, wherein the computer program, when executed by a processor, implements the method according to claim 1.
